(19) United States
(12) Patent Application Publication
(10) Pub. No.: US 2020/0346849 A1
(43) Pub. Date: Nov. 5, 2020

(54) SINGLE-DOSE CAPSULE FOR MACHINES DELIVERING INFUSED BEVERAGES

(71) Applicant: IMPER S.P.A., Torino (TO) (IT)

(72) Inventor: Roberto STEFANONI, Oggiono (LC) (IT)

(73) Assignee: IMPER S.P.A., Torino (TO) (IT)

(21) Appl. No.: 16/957,936

(22) PCT Filed: Jan. 23, 2019
(86) PCT No.: PCT/IB2019/050551

§ 371 Date: Jun. 25, 2020

(30) Foreign Application Priority Data
Jan. 24, 2018 (IT) 102018000001713

(51) Int. Cl. B65D 85/804; A47J 31/40

(52) U.S. Cl. CPC B65D 85/8043; A47J 31/0673; A47J 31/407

(57) ABSTRACT

A single-dose and single-use capsule for use in a machine for dispensing beverages in form of infusion is provided. The capsule has a main cup-shaped body that bears a concentrated product in granular form, and the main body is defined by a lateral coat substantially truncated cone shaped and by a circular bottom wall. The bottom wall has:
a plurality of drilling regions, which, in use, are perforated by one or more perforating elements of the dispensing machine during an infusion cycle; and
a plurality of reinforcing regions, arranged adjacently and alternately to the perforation regions and having enhanced thickness with respect to them,
wherein, in use, the reinforcing regions avoid slots or cracks which extend from holes made onto the perforation regions to propagate.

### TECHNICAL FIELD OF THE INVENTION

The present invention relates to, in general, the sector of preparing hot beverages in form of infusion—for example coffee, tea, tisane and the like—from a capsule, the latter in particular of single-dose and single-use type, which is to be inserted in a dispensing machine.

### STATE OF THE ART

Many machine models are known and widely distributed for the extemporaneous preparation of hot beverage in form of infusion, for example coffee, tea, tisane and the like, starting from a capsule. The machines in question find place in workplaces, in public places and also in the domestic field.

The capsules used—generally single-use and single-dose—have, typically, a main body in a cup shape, or truncated cone shape, often closed at an its upper base by a gas-impermeable peel. Within the main body, the capsule receives, in other words is pre-packed with, a compound typically in granular form. The final beverage is obtained through a so-called “extraction” process, which consists of making a high temperature liquid, typically water,

pass through the capsule. The liquid, after such “infusion” through the product contained in the capsule, realizes the beverage which is dispensed to the consumer.

During the infusion cycle, to allow the extraction phase, the capsule is drilled at the bottom of its main body by special perforators of the dispensing machine. The holes so made allow the passage of a liquid flow longitudinally through the capsule. Depending on the typology of dispensing machine, the liquid can proceed from the bottom of the cup-shaped body towards the top or in the opposite direction.

Any dispensing machine makes use of an its own specific infusion head and/or perforating elements dedicated and, consequently, only operates with a particular type of single-dose capsules, typically distinguished by a peculiar conformation of the main body. Further to amortize the costs related to typologies of different moulds and to plastic or compostable materials used, a productive trend should be that of reducing the thicknesses of the main body of the capsule. However, this demand must be related to the need to guarantee for an appropriate pressure seal during the infusion cycle and to prevent possible deformations of the capsule during the transportation and storage phases.

Furthermore, the Inventors experienced that, when drilling the bottom of the capsule, a crack, or anyhow a lesion, often originates at the edges of the hole, which tends to show an “eye of partridge” conformation. Such situation is exemplified in FIGS. 1 and 1A, that indeed show a capsule of the known type, denoted by the reference A, during the extraction phase immediately after the penetration of drilling knifes or tips F at the bottom B of the capsule itself. The elongated deformation of each hole O and the generation of lateral cracks C, that depart from the ends of the hole itself, can be precisely noted.

Such drawback worsens the infusion conditions, because makes the inflow and/or outflow conditions of the liquid, and the pressure regimen inside the capsule, less controlled and, moreover, potentially facilitates leakage of granular material from the capsule.

### SUMMARY OF THE INVENTION

The technical problem posed and solved by the present invention is therefore to provide a capsule, in particular single-dose and/or single-use, for the use in machines for dispensing beverages in form of infusion, that allows to overcome one or more drawbacks previously cited referring to the state of art.

Such technical problem is solved by a capsule according to claim 1 and by a capsule in combination with a dispensing machine according to claim 18.

Preferred features of the present invention are subject matter of the dependent claims.

The capsule according to the invention has, at an its own bottom and in particular at the internal side thereof that faces the packaged product, one or more reinforcing regions, in particular one or more regions of enhanced thickness or one or more raised regions. In other words, the bottom of the capsule bears portions of differentiated thickness, or level, and in particular an alternation of portions of major thickness and minor thickness or an alternation of raised and reduced regions that can or cannot share a same inferior or bottom surface. The region or the regions of minor thickness are intended to be drilled by means of one or more perforating elements of the machine for dispensing beverages. In yet other words, on the bottom capsule thickened zones alternated with perforation zones, of thin thickness, are obtained.

The structure of the proposed capsule hence provides one or more ribs or reinforcements. According to a mostly preferred configuration, the hole is obtained in a minor thickness, or reduced, region, which bears at least one enhanced thickness or raised adjacent portion. More preferably, the minor thickness, or reduced, region is obtained between two enhanced thickness o raised regions, in particular concentric thereto. Thereby, the region or the regions of enhanced thickness avoid cracks or widenings originated at the edges of the hole to form or to propagate.

In other words, the benefit borrowed by the enhanced thickness or raised zones is to avoid the material neither to crack nor to produce slots in the drilling point known as “eye of partridge”. Consequently, the performances of dispensing coffee are not affected both in terms of flavour and quality.

Advantageously, the perforation and reinforcing region or regions have circumferential development. In particular, they are realized in form of concentric circular crowns alternately radially arranged.

The structure of capsule of the invention proves to be particularly apt to and useful in case of realizing the main body of the capsule itself in recyclable material, in particular compostable. This type of material, indeed, is known to be the more fragile among many others.

Furthermore, the capsule is particularly suitable and useful in case of injection or co-injection design, for example with a structure of capsule and/or method of packaging such as the subject of the Italian Patent no. 102014902270816 and International Application (PCT) pubbl. no. WO 2017/103952.

The possibility to make use of a plastic injection process allows to design the ribs or reinforcements above mentioned in such an extremely effective, efficient and, where necessary, differentiated way depending on the capsule type.

In a preferred embodiment, the capsule has a main body, in particular cup-shaped, realized in multilayer form comprising an inner layer and an outer layer made of structural material, for example polypropylene, and an intermediate layer made of barrier material, for example a polyvinyl ethylene-alcohol copolymer, apt to prevent the passage of oxygen from the external environment inwards the main body.

The capsule of the invention may be configured to contain both products in granular form, i.e. particle of any size or conformation, and products in concentrated liquid form, such as syrup.

Other advantages, features and modes of use of the present invention will become evident from the following detailed description of several embodiments, introduced by the way of non-limiting examples.

### BRIEF DESCRIPTION OF THE FIGURES

Reference will be made to figures of the attached drawings, wherein:

FIGS. 1 and 1A, already above introduced, refer to a capsule of prior art during a perforation phase of the bottom thereof in a machine for dispensing beverages, showing a frontal prospective longitudinal-sectional view of the capsule itself and a plan view of a detail of the bottom thereof, respectively;

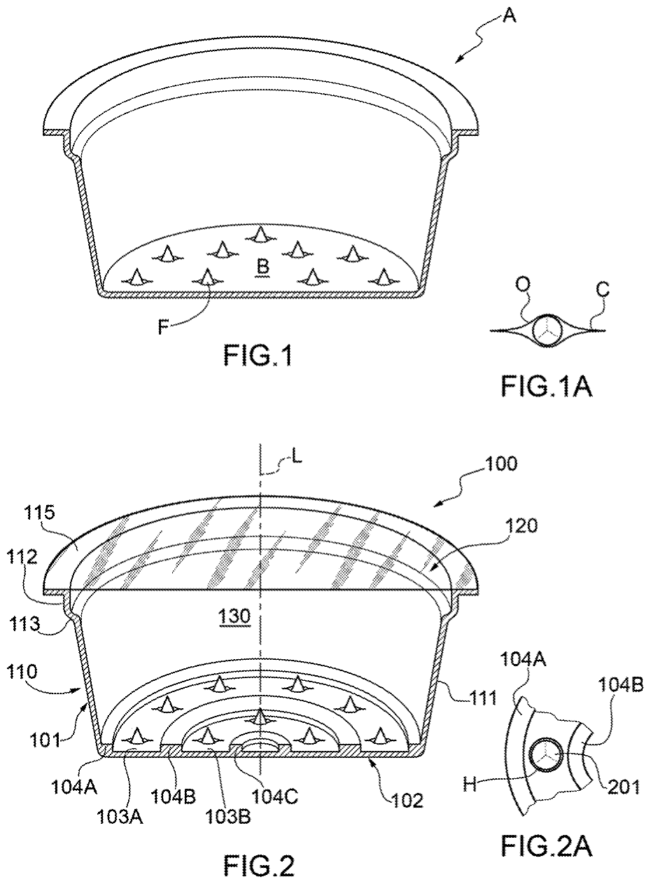

FIGS. 2 and 2A refer to a preferred embodiment of a capsule according to the present invention, showing a frontal prospective longitudinal-sectional view of the capsule itself and a plan view of a detail of the bottom thereof during a perforation phase said bottom, respectively;

FIG. 3 shows a frontal prospective longitudinal-sectional view of the capsule of FIG. 2, before the perforation phase;

Figures from 4A to 4C refer to the capsule of FIG. 2, the capsule being depicted after the perforation, and by frontal prospective longitudinal-sectional view and plan view from below, respectively,

FIG. 5 refers to another preferred embodiment of a capsule according to the present invention, showing a partial prospective longitudinal-section view thereof.

The thicknesses and the curvatures shown in the Figures above introduced are to be intended by the way of examples of not necessary in proportion. To better represent them, any upper closing element, for example in form of peel, has been shown for the capsules.

### DETAILED DESCRIPTION OF PREFERRED EMBODIMENTS

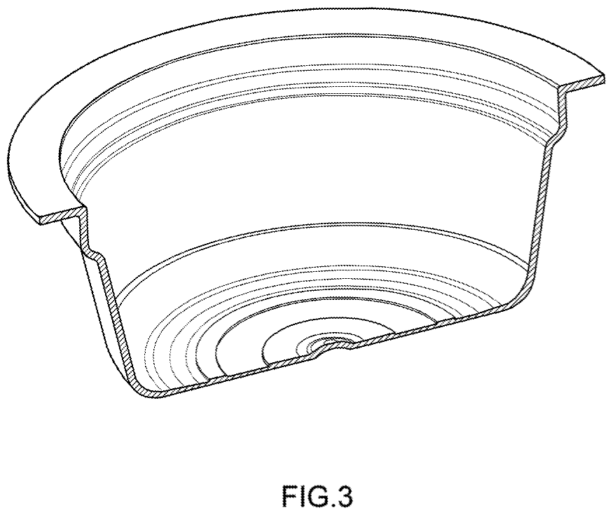

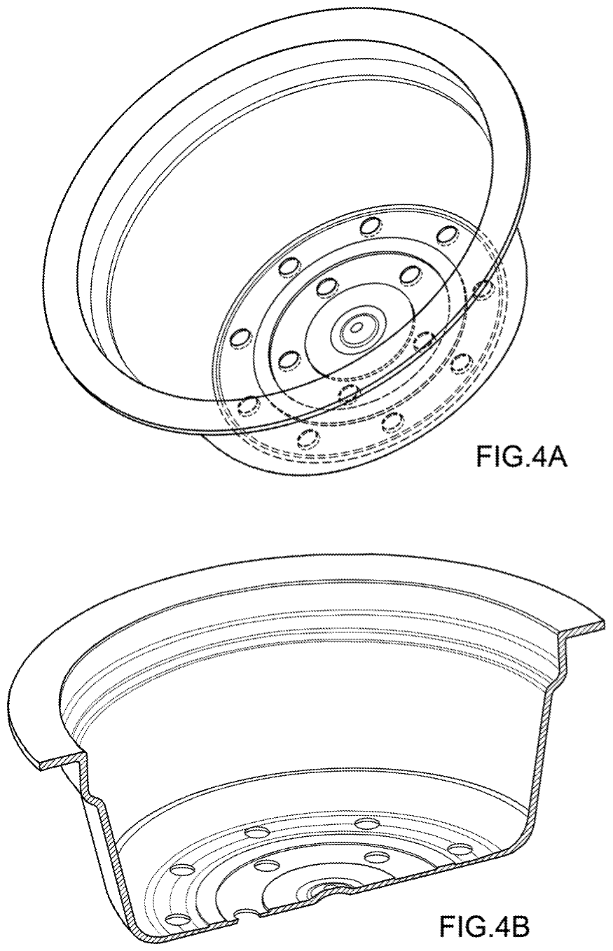

Initially referring to FIGS. 2 and 3, a capsule according to a preferred embodiment of the invention is overall denoted by 100.

The capsule 100 is single-dose and single-use type and is intended to be used in a machine for dispensing beverages in form of infusion.

The capsule 100 comprises a main body 110 substantially cup-shaped, which in this example has a conformation generally tapered and, in particular, with cylindric geometry. Advantageously, the main body 110 has a longitudinal axis of symmetry L and is mainly defined by a lateral coat 101 and by a bottom wall 102.

The lateral coat 101 comprises a principal containment portion 111 with substantially truncated cone geometry, which is enclosed at one end thereof, in particular the inferior end, by the bottom wall 102.

The lateral coat 101 has also an upper enlarged portion 112 integral with the principal portion 111 and bound thereto at a transition portion 113 that substantially defines a step. The enlarged portion 112, superiorly arranged with respect to the principal portion 111 in the example here considered, has a develop substantially cylindrical or truncated cone. The enlarged portion 112 has longitudinal extension inferiorly to the principal portion 111 and ends, at its longitudinal end opposite to the transition region 113, with a flange radial 115 with circumferential geometry and main extension along a plane orthogonal with respect to the symmetry axis L.

The main body 110 hence defines an internal room 130 that receives a compound or concentrated product in granular or liquid form, for example coffee powder or syrup, not shown in the Figures for a greater clarity of representing the structure of the capsule.

The room 130 is accessible during packaging phase, to introduce a predetermined amount of product, at an upper opening defined along the perimeter by the flange 115.

Along the flange 115 it is possible to apply a peel 120, or a different thin closing element, in particular in a film form. Preferably, such closing element 120 is gas-impermeable and apt to seal the said concentrated product in the capsule 100.

According to the present embodiment, at the bottom wall 102 the capsule has a plurality of perforation regions, each generically denoted by 103, in particular two regions 103A and 103B in the depicted example. Each perforation region 103 is alternately arranged to a reinforcing region 104 of a corresponding plurality. In the depicted example, three reinforcing regions 104A, 104B and 104C are provided. The reinforcing regions 104 have thickness raised with respect to the perforation regions 103, hence defining several ribs, thickened or raised parts of the bottom wall 102.

Advantageously, the present embodiment provides each of said regions 103 and 104 in form of complete circular crown. In particular, such circular crowns are symmetrical with respect to the longitudinal symmetry axis L. The radial space between two homologous perforation regions 103 or reinforcing regions 104 is engaged by the adjacent region of the other type.

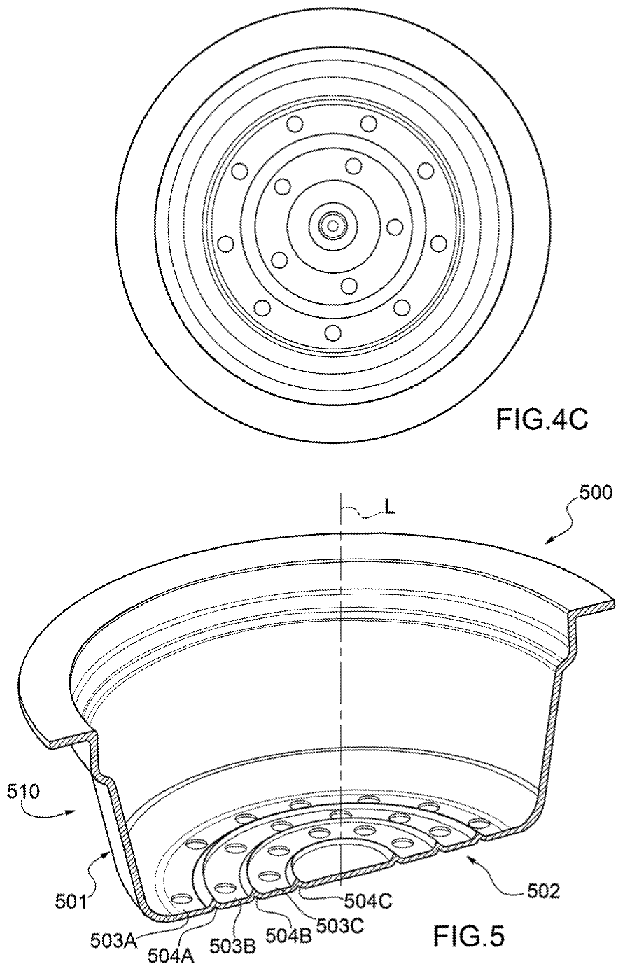

FIG. 5 shows a capsule according to one alternative embodiment of the invention that is overall denoted by 500.

Even the capsule 500 is single-dose and single-use type and is intended for the use in a machine for dispensing beverages in form of infusion.

The capsule 500 comprises a main body 510 substantially cup-shaped, that has a lateral coat 501 similar to that from the embodiment of FIG. 2 and which will be no longer discussed.

The main body 510 is also defined by a bottom wall 502 which seals a principal containment portion of the lateral coat 501 from the bottom, according to what above described referring to the embodiment of FIG. 2.

According to the present embodiment, at the bottom wall 502 the capsule has a plurality of perforation regions, each generically denoted by 503, in particular three regions 503A, 503B and 503C in the depicted example. Each perforation region 503 is arranged alternately to a reinforcing region 504 of a corresponding plurality. In the depicted example, three reinforcing regions 504A, 504B and 504C are provided. The reinforcing regions 504 are raised with respect to the perforation regions 503, hence defining ribs, thickenings transversal or radial or raised parts of the bottom wall 502. Each reinforcing region 504 presents, in the longitudinal section shown in FIG. 5, a profile substantially “V” overturned shaped.

Advantageously, the present embodiment provides each of said regions 503 and 504 in form of a complete circular crown. In particular, such circular crown are symmetrical with respect to the longitudinal symmetry axis L of the main body 510. The radial space between two homologous perforation regions 503 or reinforcing regions 504 is engaged by the adjacent region of the other type.

The main body of the capsule can be made of compostable material.

Advantageously, the main body can be obtained through an injection process or co-injection, that allows to easily and efficiently shape the body itself to the desired conformation.

In embodiments, the main body can be of multilayer type and, for example, can comprise an inner layer and an outer layer made of a structural material, such as for example polypropylene, and an intermediate layer made of a barrier material apt to prevent the passage of oxygen from the external environment to the internal room. Materials with barrier function apt to be used are, for example, copolymers of polyvinyl ethylene-alcohol known as EVOH.

The main body, if made of multilayer material, can be obtained through process of co-injection of the structural material and of the material with barrier function, which materials use injector nozzles with coaxial channels, such that e.g. disclosed in the European patent EP 1426160 B1. In such processes, the barrier material is injected through a central channel of the nozzle, while the structural material is injected through a channel coaxial thereto, so that the flow results to be consisting of a “core” of barrier material surrounded by a “skin” of structural material.

The use of a multilayer material as above described, obtained through co-injection of a structural material and of a barrier material, allows to make a capsule intrinsically protected against the oxygen inflow without the need to make use of special and expensive packaging aimed to the purpose.

According to an embodiment of the invention, the gas-impermeable peel that seals the top of the main body can be made of a polycoupled or multi-layered material comprising a first layer of polyethylene terephthalate (PET) with thickness preferably comprised between 10 and 15 micron, an aluminium second layer with thickness comprised between 35 and 40 micron and a third layer di polypropylene (PP) with thickness in the order of the 20 micron.

Alternatively, the peel may be made of a polycoupled or multilayer material comprising a first layer of polyethylene terephthalate modified with EVOH with thickness preferably comprised between 10 and 15 micron, a second layer of polyethylene terephthalate with thickness preferably comprised between 10 and 15 micron and a third layer of polypropylene with thickness in the order of 30 micron.

Yet alternatively, the peel may be made of a multilayer material comprising a first layer of aluminium with thickness preferably comprised between 35 and 40 micron and a second layer of polypropylene with thickness in the order of 20 micron.

Anyhow, the layer in polypropylene is preferably arranged in contact with the cup-shaped body to allow the peel to be heat sealed.

In general terms, the capsule structure and/or method of packaging may be obtained according to the Italian Patent no. 102014902270816 and corresponding International Application no. WO 2017/103952, here incorporated by this reference.

As exemplified in FIG. 2A and also shown in Figures from 3A to 3C, in use, in the example of the Figures, the capsule 100 is inserted in a machine for dispensing beverages in form of infusion and indeed subjected to an infusion cycle. At an extraction phase of the beverage, the capsule is pierced by many perforating elements 201, each of which realizes indeed a hole at corresponding perforation region.

The configuration described makes the reinforcing regions prevent slots or cracks, which depart from a hole made onto the adjacent perforation region, from spreading.

The present invention has been hitherto described referring to preferred embodiments. It is to be intended that other embodiments may exist which belong to the same inventive core, as defined by the scope of the claims reported hereinafter.

1. A capsule in particular of a single-dose type, for use in a machine for dispensing beverages in form of infusion, which capsule comprises a main cup-shaped body adapted to receive a concentrated product in a granular or liquid form, which cup-shaped main body is defined by a side skirt and by a bottom wall,
wherein said bottom wall has:
at least one perforation region, configured to be drilled by one or more perforating elements of the dispensing machine during an infusion cycle; and
at least one reinforcing region, arranged adjacent to said perforation region and having an increased thickness or a rise with respect to said perforation region,
wherein the reinforcing region prevents the propagation of cracks or fissures that branch off from a hole made on the adjacent perforation region.

2. The capsule according to claim 1, wherein said bottom wall has a plurality of perforation regions and/or a plurality of reinforcing regions, the perforation and reinforcing region(s) being arranged mutually alternated.

3. The capsule according to claim 1, wherein said cup-shaped main body has a circular symmetry conformation with respect to a longitudinal symmetry axis (L).

4. The capsule according to claim 1, wherein said cup-shaped main body has at least a containment portion with a substantially frusto-conical shape and wherein said bottom wall defines a circular smaller base of said frusto-conical shape.

5. The capsule according to claim 4, wherein said perforation and reinforcing region(s) are concentric regions, each extending with a circumferential development on the bottom wall.

6. The capsule according to claim 5, wherein each or said perforation region and/or said or each reinforcing region extends as a complete circular crown on the bottom wall.

7. The capsule according to claim 1, wherein said or each reinforcing region is in the form of a rib.

8. The capsule according to claim 1, wherein said cup-shaped main body is made of a compostable material.

9. The capsule according to claim 1, wherein said cup -shaped main body is of a multilayer type and comprises an inner layer and an outer layer made of a structural material and an intermediate layer made of a barrier material to prevent the passage of oxygen from the external environment.

10. The capsule according to claim 9, wherein said structural material is polypropylene and said barrier material is a polyvinyl ethylene-alcohol copolymer.

11. The capsule according to claim 1, wherein said cup-shaped main body is obtained by an injection or co-injection process.

12. The capsule according to claim 1, which is configured so that the infusion liquid enters through one or more holes formed in the bottom wall of the cup-shaped main body and exits through a top of the capsule, or vice-versa.

13. The capsule according to claim 1, wherein said main body is closed at the top by means of a closing element, in particular in the form of a film or peel, which closing element is preferably impermeable to gas.

14. The capsule according to claim 1, which is of the single-dose and/or single-use type.

15. The capsule according to claim 1, which includes the granular concentrated product received within said main body.

16. In combination, a capsule according to claim 1 and a machine for dispensing beverage in form of infusion, which machine comprises one or more piercing elements, configured to perforate the bottom wall of said capsule at a perforation region thereof, such that one or each hole made by said or each piercing element is confined by a reinforcing region of said bottom wall or between two reinforcing regions adjacent to the perforation region.

17. The capsule according to claim 1, wherein said or each perforation region is arranged between two adjacent reinforcing regions.

18. The capsule according to claim 1, wherein said or each reinforcing region has, in a longitudinal section according to a longitudinal axis of the capsule, a sectional profile shaped substantially as an overturned “V”.
